(19) United States
(12) Patent Application Publication
(10) Pub. No.: US 2017/0210561 A1
(43) Pub. Date: Jul. 27, 2017

(54) PALLETIZED STORAGE AND DISTRIBUTION SYSTEM

(71) Applicant: Sabil Abdelali, Sterling Heights, MI (US)

(72) Inventor: Sabil Abdelali, Sterling Heights, MI (US)

(21) Appl. No.: 15/286,266

(22) Filed: Oct. 5, 2016

Related U.S. Application Data
(60) Provisional application No. 62/237,149, filed on Oct. 5, 2015.

(51) Int. Cl. B65G 1/04; B65G 1/10

(52) U.S. Cl. CPC B65G 1/0471; B65G 1/10

(57) ABSTRACT

An apparatus for presenting components stored in segmented bottomless trays, and removing empty trays having a base member having an input and an output portion; a discharge area; a shuttle member which removes segmented storage trays and places them in the discharge area.

### CROSS-REFERENCE TO RELATED APPLICATIONS

This application claims the benefit of U.S. Provisional Application No. 62/237,149, filed on Oct. 5, 2015. The entire disclosure of the above application is incorporated herein by reference.

### FIELD

The present disclosure relates to a robotic distribution system pallet, and more particularly to a palletized storage system having a plurality of robotic table system that engages segmented bottomless drawers.

### BACKGROUND AND SUMMARY

This section provides background information related to the present disclosure that is not necessarily prior art. This section provides a general summary of the disclosure, and is not a comprehensive disclosure of its full scope or all of its features.

The present invention relates to devices for controlling delivery of a product and/or products containers of substantial size in manufacturing or distribution operations to an improved material storage and delivery structure and system for storing, delivering, positioning and removing both full and empty products containers to and from distribution or production line workstations as desired.

As is well known, distribution or production line facilities require the delivery and temporary storage of large volumes of parts at or near distribution or production line workstations to support distribution operations on a continuous mass production basis. Production line or distribution line operations in particular require the delivery of large numbers of parts of varying size for distribution to automotive or truck vehicles or subsystems thereof, on a continuous basis.

The continuous delivery of a large number of such products to manufacturing lines during any particular work shift, typically require the movement positioning and temporary storage of large numbers of such segmented trays at the production facility. Substantial floor space is thus often needed for movement and repositioning of both full and empty trays to facilitate delivery of full trays to the production line and removal of empty trays when the production parts contained in each tray has been fully depleted. Typically, the line operators move empty trays into a position out of the way. Due to the size and weight of these empty trays, significant ergonomic problems have arisen.

It is, therefore, desirable to provide a part or item container storage and delivery system that facilitates the delivery of fresh trays of parts to a robotic system as needed. It is further desirable to provide such a system which stores in positions full and empty production part trays as desired and which facilitates the storage, delivery, positioning and removal of a sufficient number of such products to obviate the need for supplemental vehicle intervention over the entire work shift. It is also desirable to provide a system that enables production workers to index the height of the trays at the workstation as needed to improve ergonomic conditions.

The present invention is intended to satisfy the above desirable features through the provision of a new and improved container storage and delivery structure and system which is designed in structural modules operative to define a base portion having an input and output portion, a shuttle slide for sliding and positioning empty trays into a discharge portion, and a shuttle or conveyor for conveying the empty trays into the discharge portion.

In one embodiment of the invention, the output portion has a translatable table and a slide. These components allow the operator or a robot to position the components stored in the trays in the most ergonomically efficient position. The system further has a controller for controlling the operation of the conveyor and the slide, with the system shuttling empty trays and stacking them properly in the discharge position.

The above and other features of the invention will become apparent in the reading of the detailed description of the preferred embodiments, which makes reference to the following sets of drawings.

Further areas of applicability will become apparent from the description provided herein. The description and specific examples in this summary are intended for purposes of illustration only and are not intended to limit the scope of the present disclosure.

### BRIEF DESCRIPTION OF THE FIGURES

FIG. 1 represents a rack system which accepts the T-pallet and the associated robotic system of the present teachings;

FIG. 2 represents a section of the rack system shown in FIG. 1 having a slidable segmented bottomless tray;

FIG. 3 represents the interaction of a picking robot according to the present teachings with the slidable segmented bottomless tray;

FIG. 4 represents a central distribution system using that rack system shown in FIG. 1;

FIG. 5 represents the removing of a bottle from the slidable segmented bottomless tray;

FIG. 6 represents the loading of rack systems into transportation vehicles;

FIG. 7 represents a movement of products to a central distribution system using that rack systems in trucks shown in FIG. 6;

FIG. 8 represents the placement of the rack system shown in FIG. 2 into a Rack system shown in FIG. 1;

FIG. 9 represents the removal of the rack system shown in FIG. 2 into a Rack system shown in FIG. 1;

FIG. 10 represents the loading of the rack system shown in FIG. 2;

FIG. 11 represents an empty rack support system as shown in FIG. 1;

FIG. 12 represents an filled rack support system as shown in FIG. 1;

FIG. 13 represents an alternate empty rack support system as shown in FIG. 1;

FIG. 14 represents the loading of an from the slidable segmented bottomless tray according to the methods disclosed herein;

FIG. 15 represents an alternate section of the rack system shown in FIG. 1 having a slidable segmented bottomless tray which is loaded according to the methods disclosed herein;

FIG. 16 represents the removal of an from the slidable segmented bottomless tray according to the methods disclosed herein;

FIG. 17-21 represent alternate sectional trays of the rack system shown in FIG. 1 having a slidable segmented bottomless tray;

FIG. 22 represents examples of goods available in the loadable in the trays shown in FIGS. 17-21 and according to the methods disclosed;

FIG. 23 represents the loading of rack assemblies into the rack system according to the methods disclosed.

FIG. 24 represents the removal of goods from the slidable segmented bottomless tray according to the methods disclosed herein; and

FIGS. 25-30 represent perspective views of the robotic picker according to the present teachings.

### DETAILED DESCRIPTION

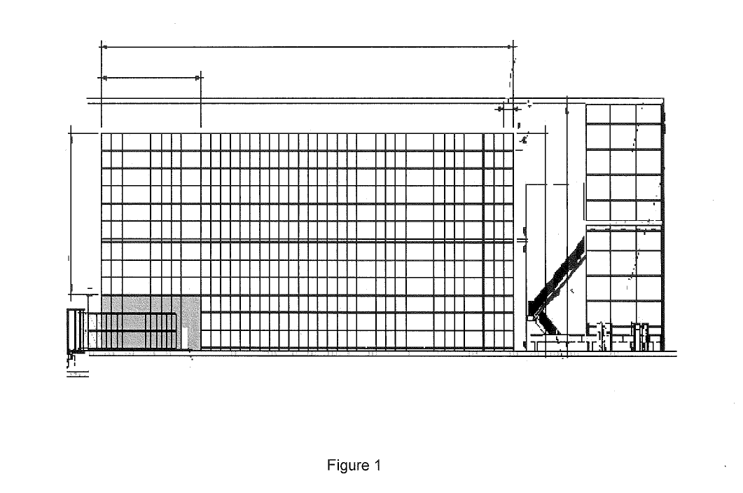

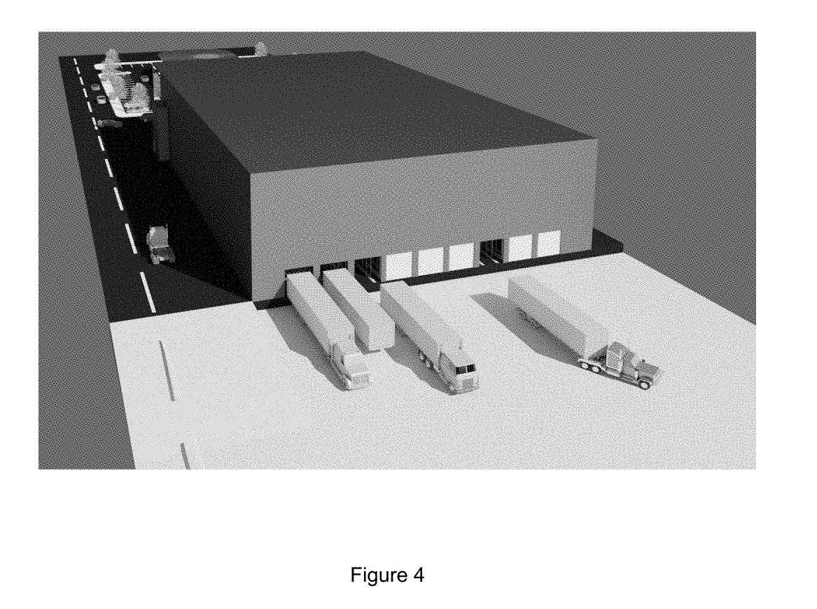

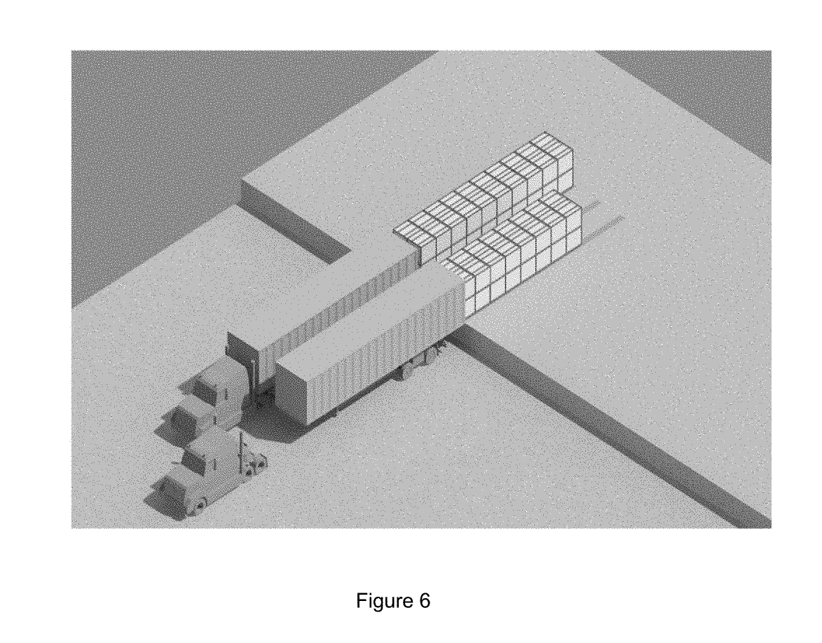

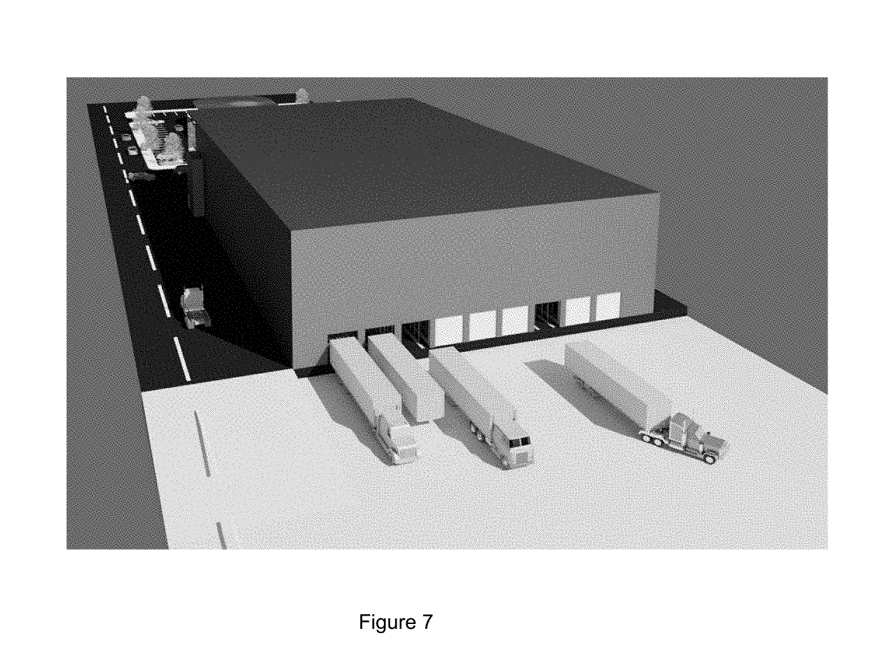

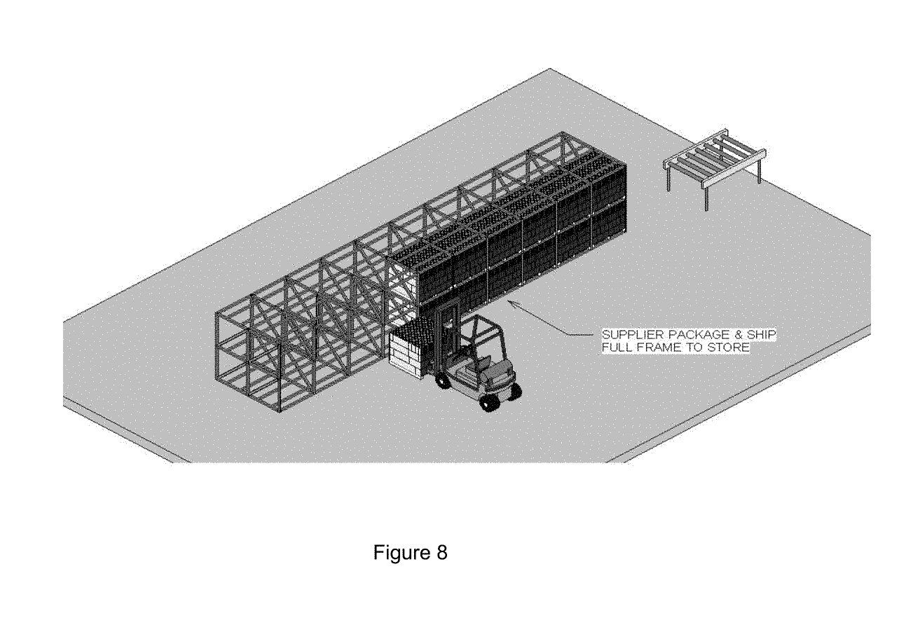

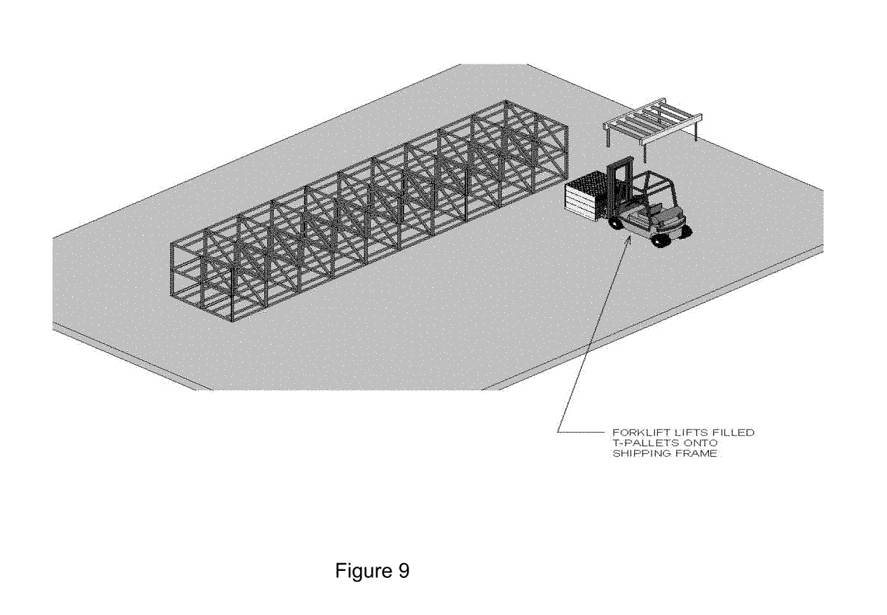

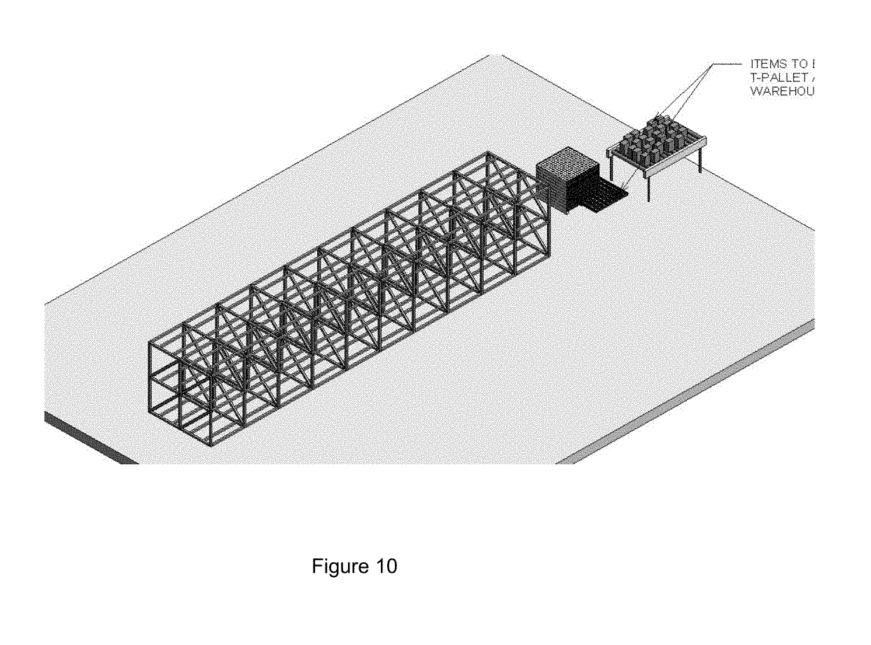

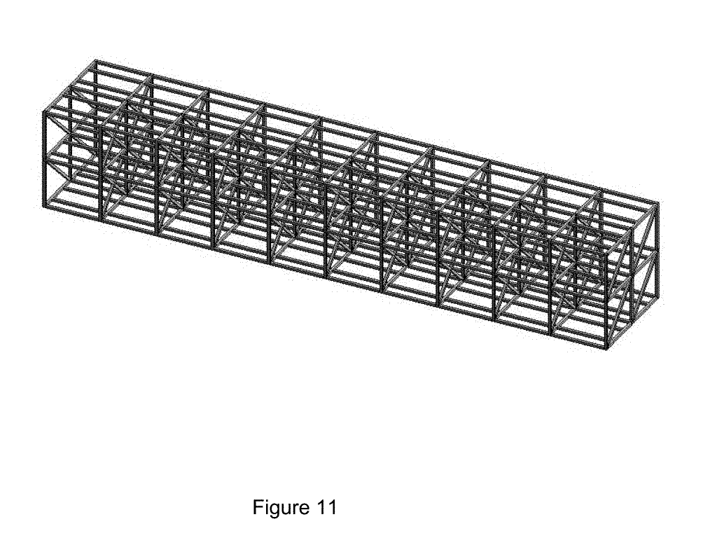

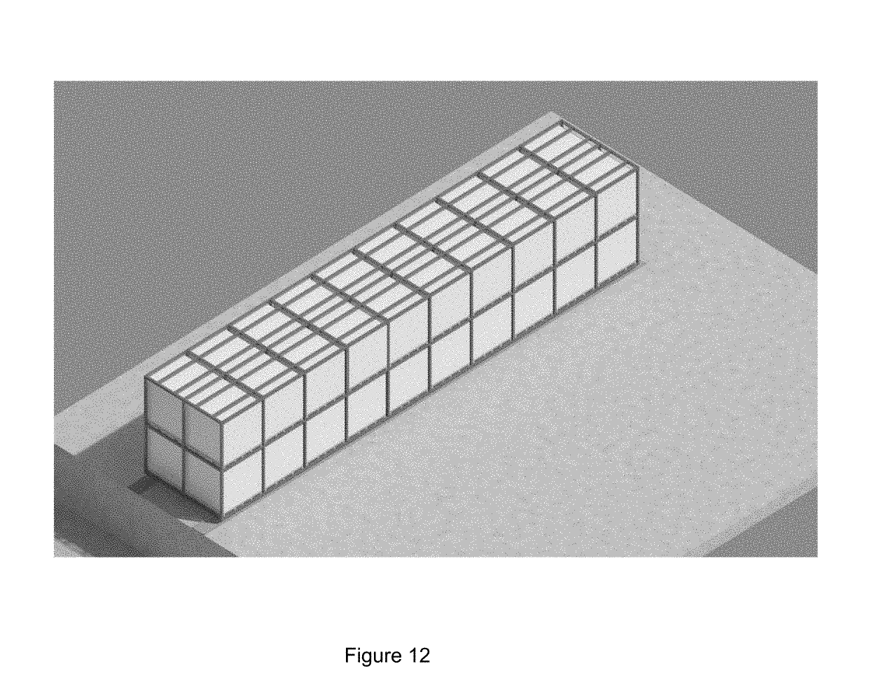

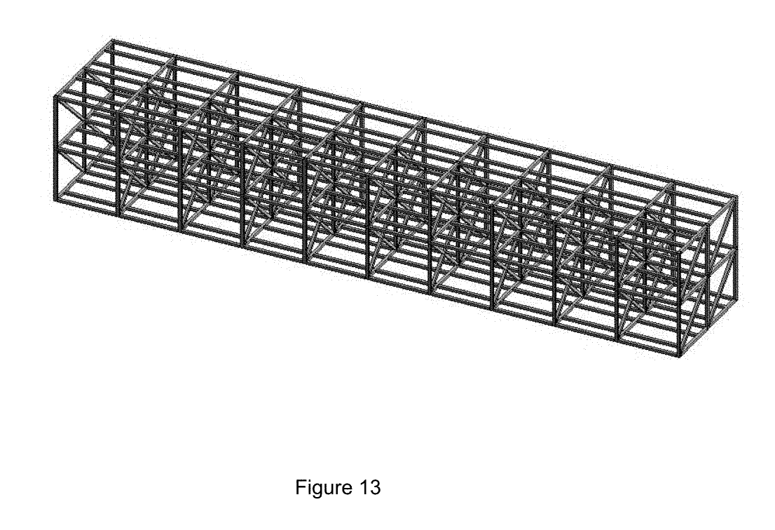

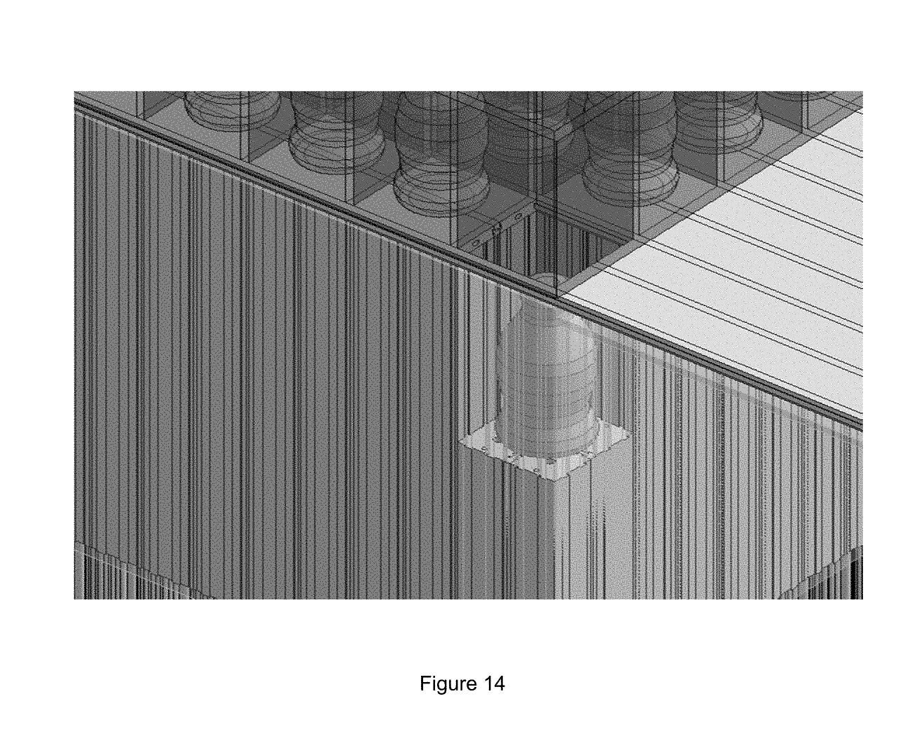

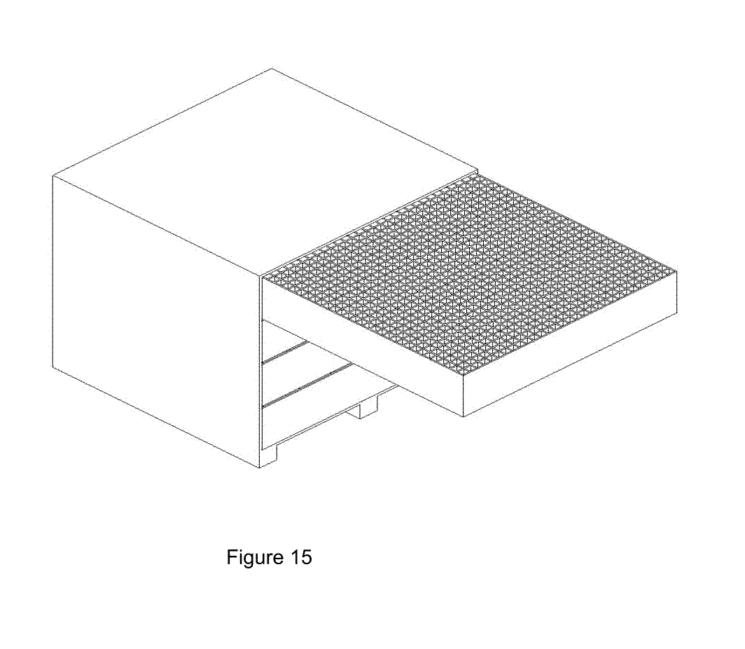

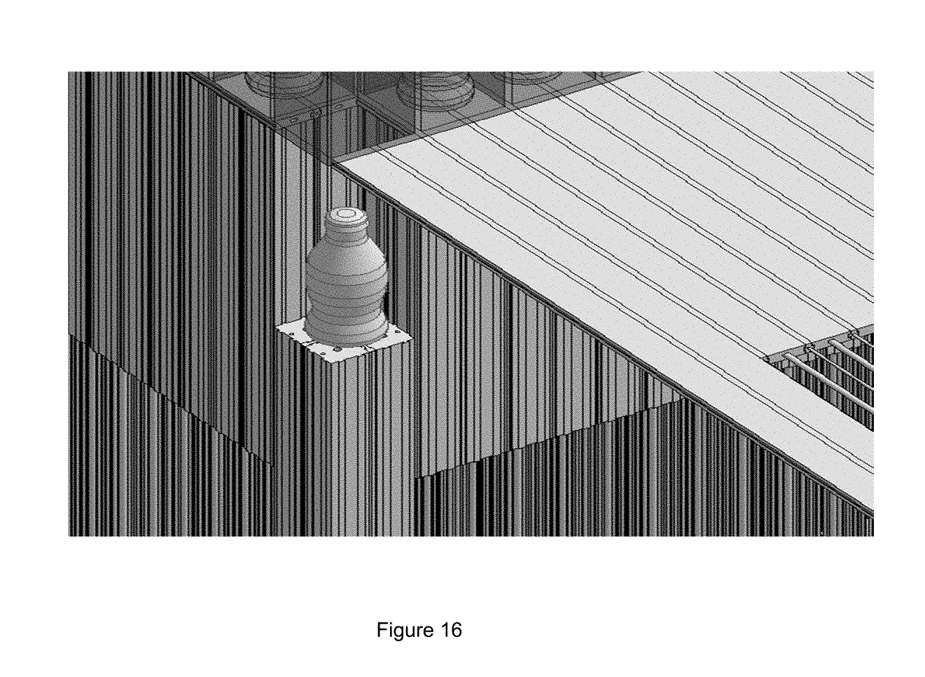

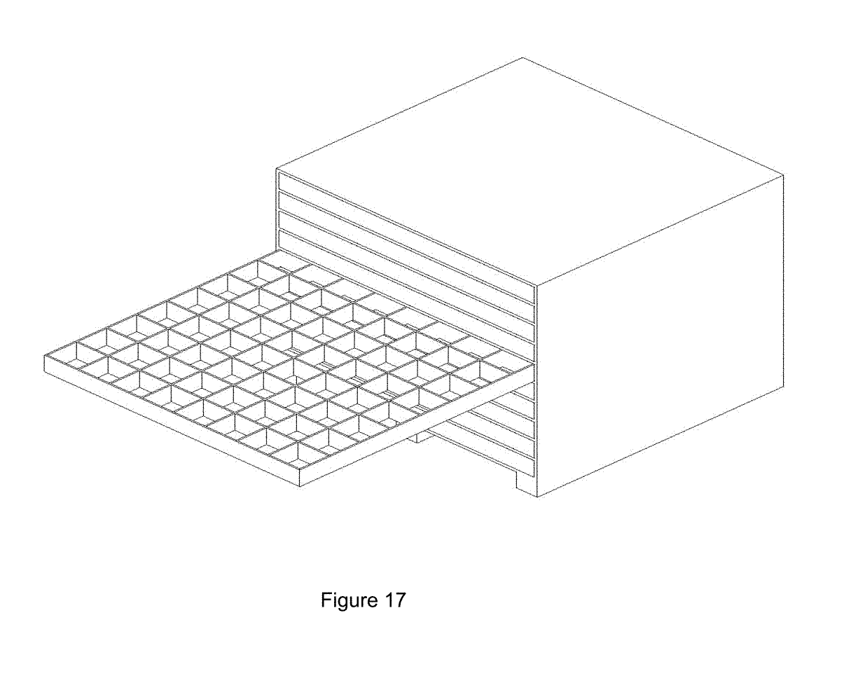

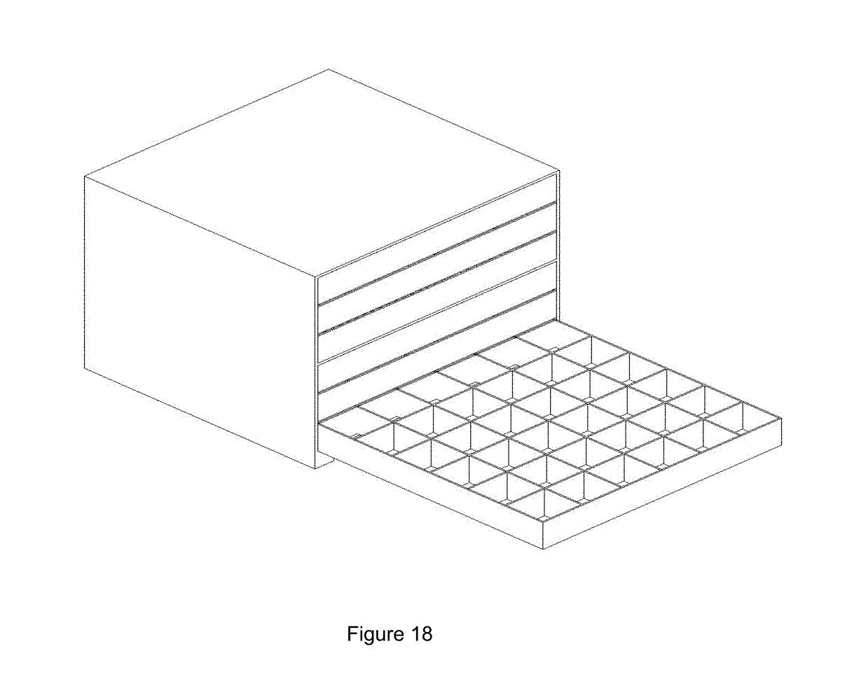

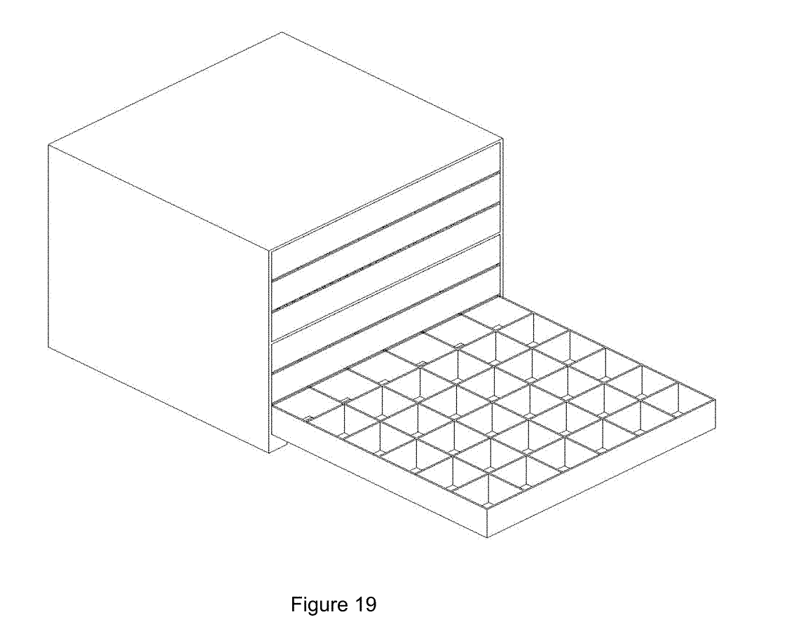

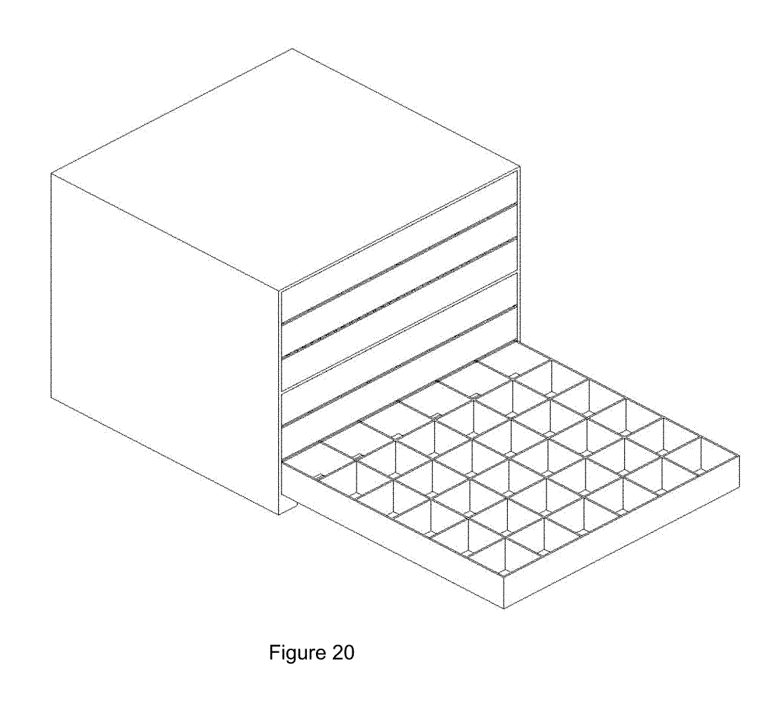

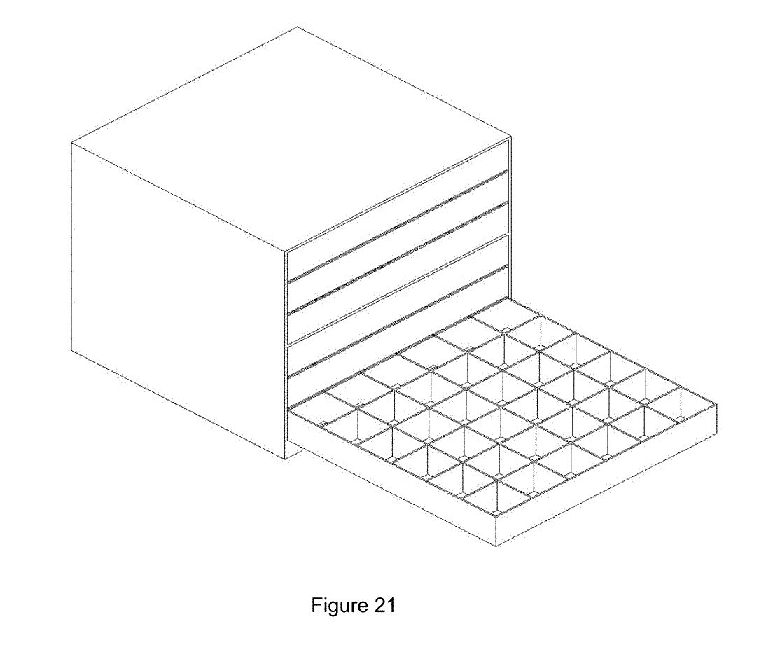

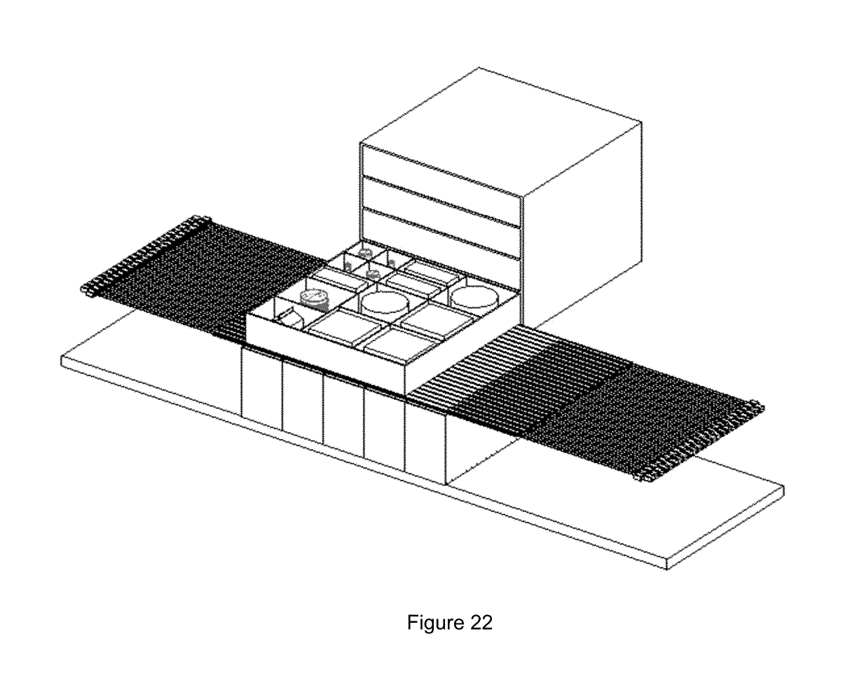

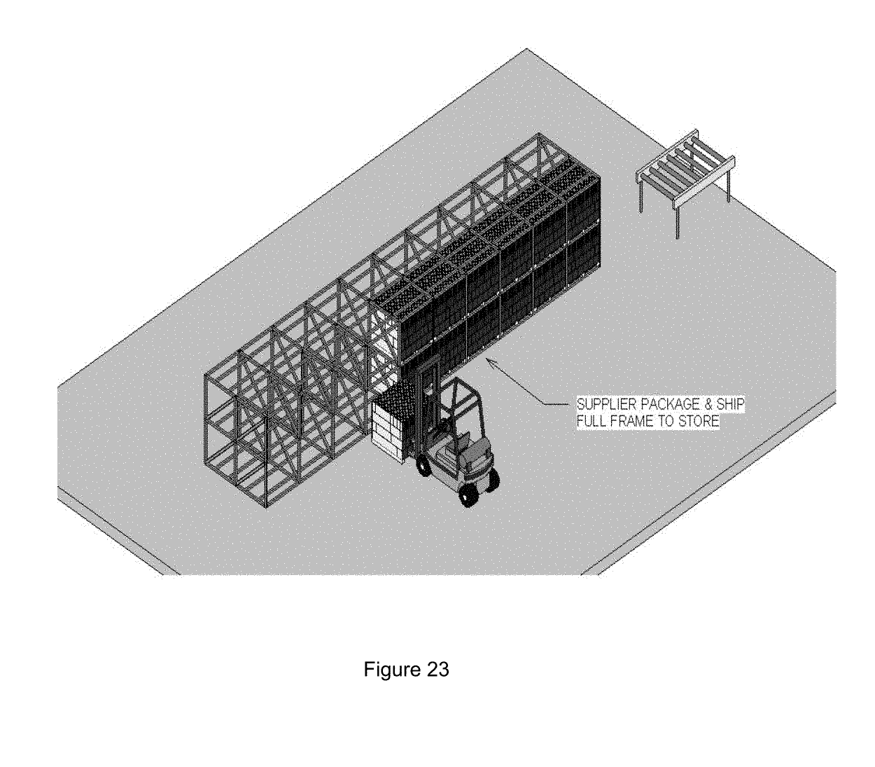

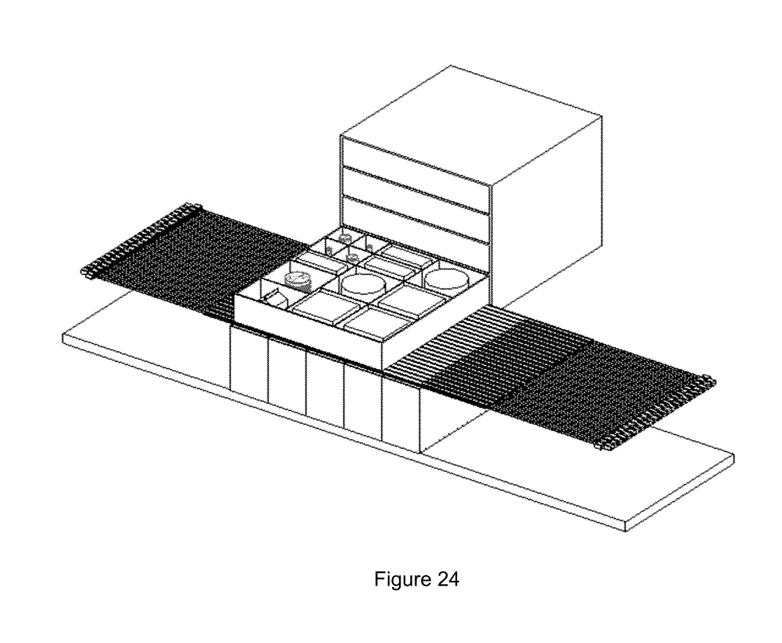

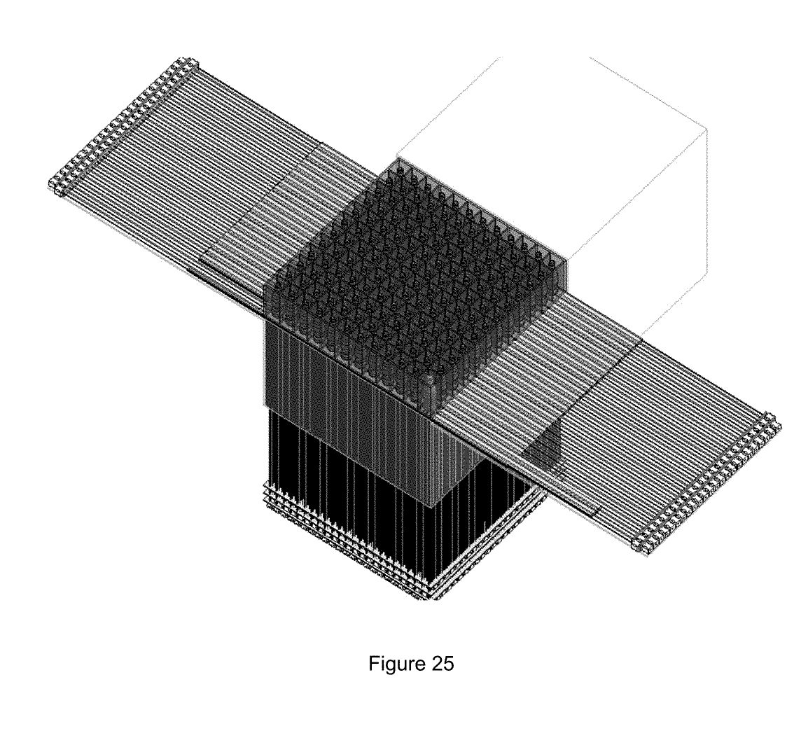

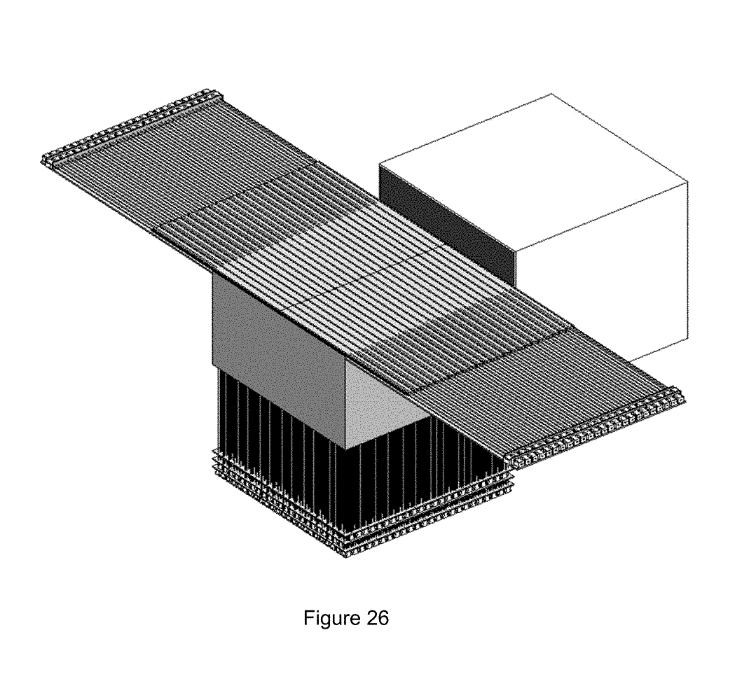

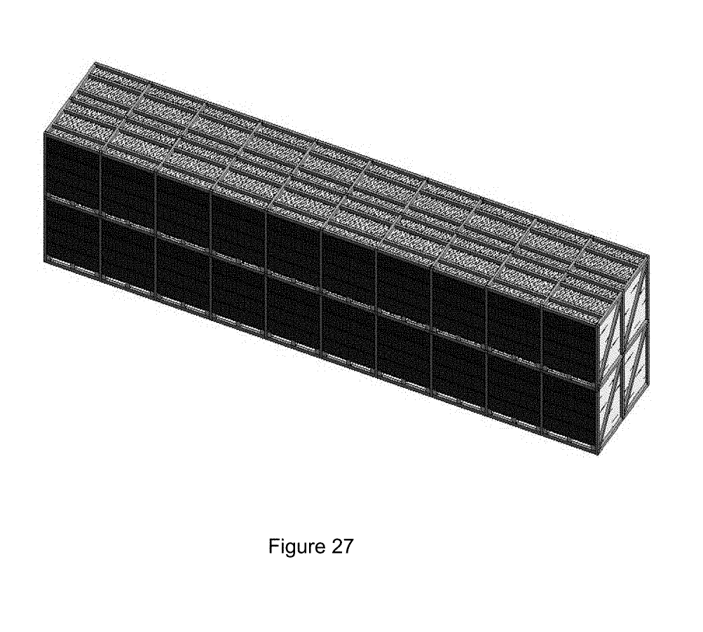

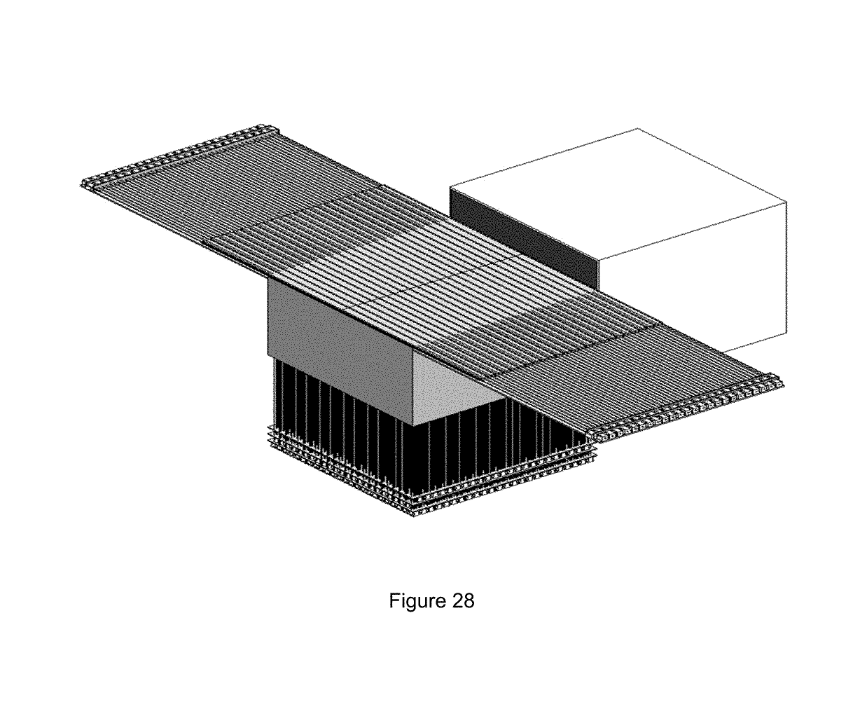

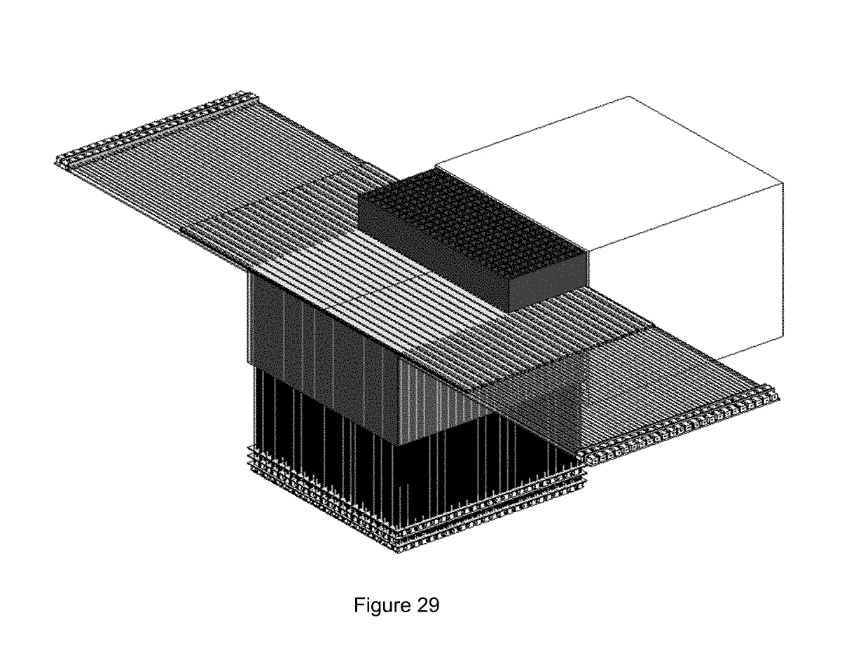

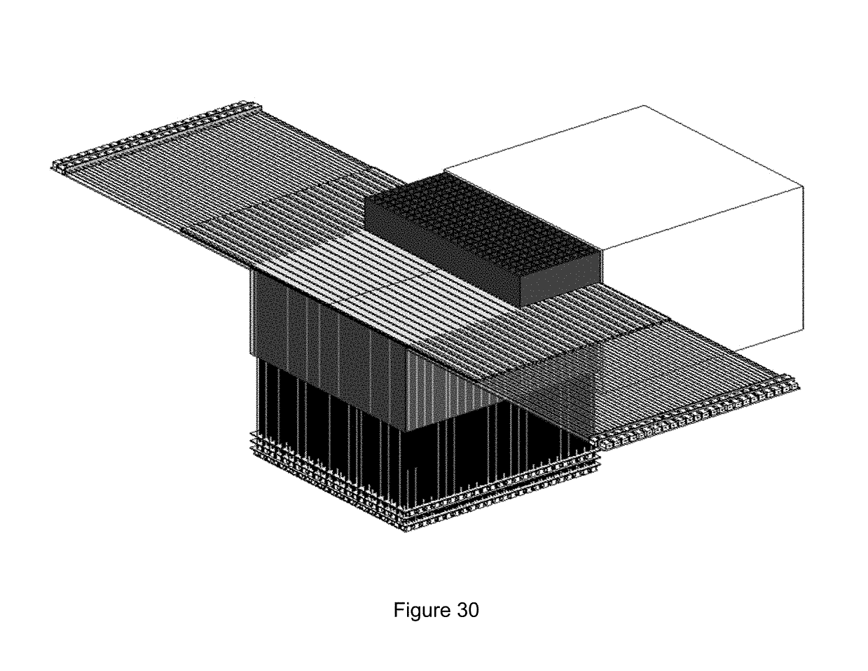

Example embodiments will now be described more fully with reference to the accompanying drawings. Referring now specifically to the drawings, a container storage and delivery structure and system in accordance with one embodiment of the present invention. The system has a base portion having an input portion, output portion and interposed table portion. The shuttle has a support member and a shuttle slide for transporting empty segmented bottomless tray containers over a discharge portion. The one of the stack of trays is placed into the input portion on the table portion by an actuator configured to slide individual trays out of a storage pallet onto the table. The pallet structure is constructed of pairs of vertical and horizontal-square tubing members that function as the support member. The discharge portion is constructed of a plurality of movable members that are vertically displaceable to define pockets for products. FIGS. 1-30 represent a rack system which accepts the T-pallet and the associated robotic system of the present teachings.

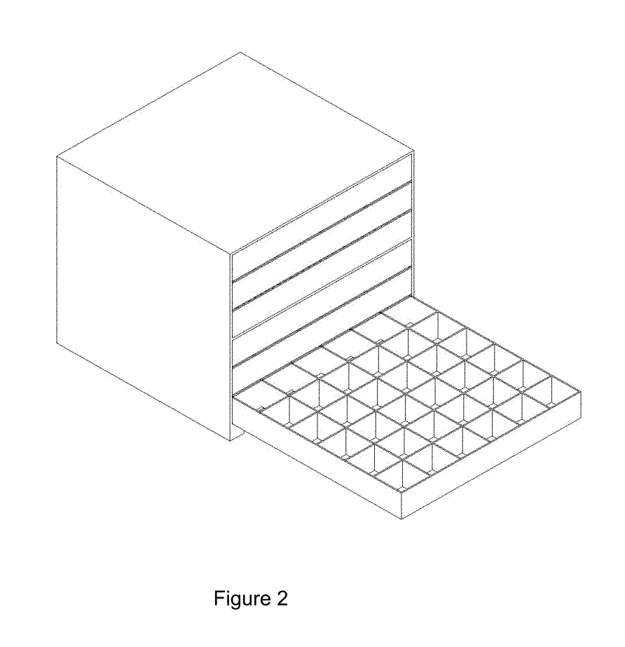

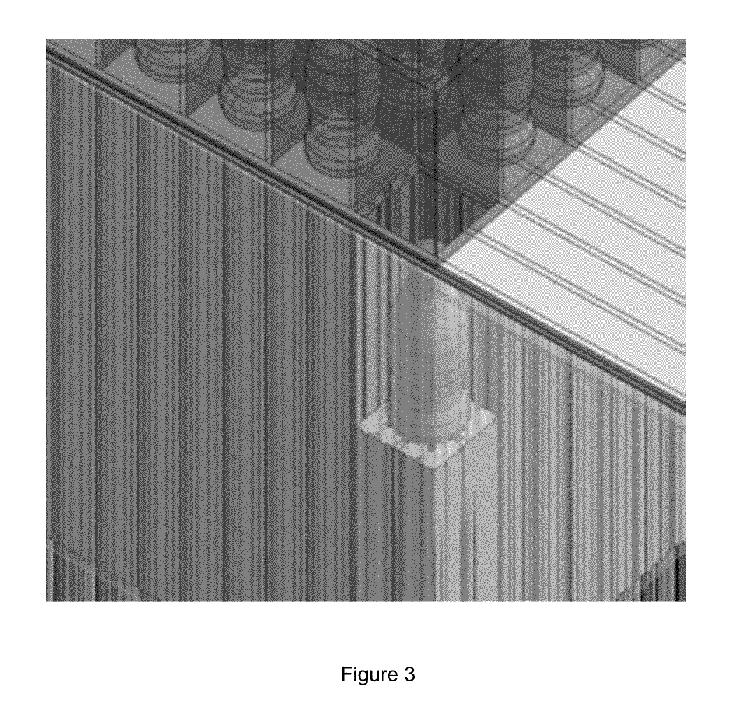

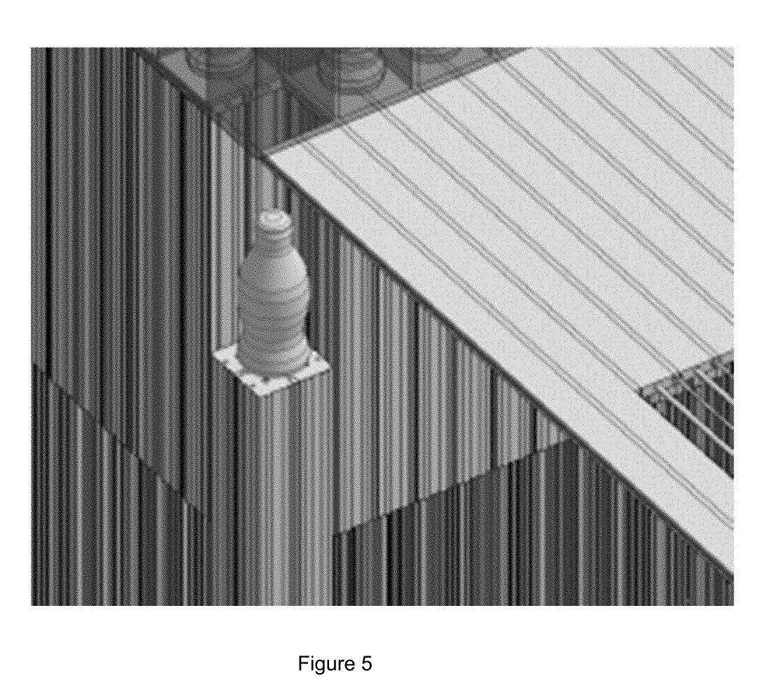

FIG. 2 represents a section of the rack system shown in FIG. 1. The rack system has a plurality of internal support layers that act as the bottom for a series of selectively insertable drawers. The drawers have dividers, without a bottom. Each drawer having a slidably segmented bottomless tray which is positioned over a picking robot. FIG. 3 represents the interaction of a picking robot according to the present teachings with the slidable segmented bottomless tray which is used in a central distribution. FIG. 5 represents the removing of a bottle from the slidable segmented bottomless tray.

The picking robot has a plurality of horizontal flat members which are slidably translatable over a plurality of vertically translatable platens. In operation, the bottomless tray is slid into position over the horizontal slidable members. A controller provides a signal to an actuator which causes the horizontal members to slide and produce an aperture beneath an item which is desired. The controller then moves the vertical translatable platen down to allow the item to translate out of the bottomless tray. The controller provides a second signal to an actuator which causes the horizontal members to slide and close the aperture beneath an item which is desired. At this point, the bottomless tray is slid back into the rack having a supporting lower surface. To fill the racks, the operation can be reversed, and the robot can be used to fill the trays from the bottom.

Table portion, which is driven by a conveyor drive, functions to transport the stack of trays over the input portion that is disposed over the output portion. The table portion has a plurality of parallel slidable members which can be a standard shuttle type, chain driven or roller type. The shuttle is shown in a lowered position, ready to transport an empty tray from the stack to the storage portion. Shown is the tray after it has been transported to the output portion by table portion. Further shown is the shuttle slide, which is used to raise the shuttle from its lower position to its fully raised position. Also shown in the output portion is a table slide for automatically sliding the trays to a number of pre-determined positions. The shuttle can have a plurality of actuators for sliding an empty tray and placing it in the discharge portion. The actuators have pins that engage either holes in the empty trays or under engaging portions of the trays.

The shuttle member can slide products into an empty tray. The table slide raises or drops products into or out of the stack trays so the top layer is at a proper predetermined level A. This allows proper access to the components stored in the trays. On shuttle is a sensor that allows the shuttle to determine its position of products within respect to the trays. Any combinations of movements of the over the horizontal slideable members can be used to allow the retrieval of the item desired. Shown is a tray being placed on the table portion.

Shown is the empty tray being conveyed by the shuttle conveyor over the discharge portion. Found on the shuttle member is a safety lock, which prevents the accidental opening of the pallet. Shown in Shown is the shuttle being lowered to a point where it is possible to safely release a product into the empty output section by actuating the actuators and allow the opening of the segmented table at a specific location within the robot. Sensor is used to determine when the shuttle is in a proper position. As can be seen, when the empty tray has been returned, the shuttle is again raised to its uppermost position and the shuttle conveyor is now allowed to move the actuators back over the stack of trays. Upon instruction by the processor, the shuttle will again lower to pick up an empty tray and deposit it on top of the segmented bottomless empty tray which has been placed in the discharge position.

Shown is a front view of the container storage system holding a stack of trays in the output portion of the base. Shown is a translatable table and a table slide for raising the stack of trays once an empty tray has been removed from the top and placed into the discharge portion. Shown is the translating table. Also shown is the table slide in the form of a screw drive slide. It should be noted, however, that this slide could be a scissor slide, a chain slide, a pneumatic slide or a hydraulic slide. The table slide is controlled by a controller found in the control panel that changes the height of the trays every time the product has been removed and placed into the discharge portion. The desired height is readily changeable by the processor. Additionally shown is a supplemental sensor that is used by the system to determine when all of the segmented bottomless trays have been removed from the output portion and to sense when a full stack of trays has been transferred to the output portion.

The system has a controller stored in control panel. The controller controls the conveyor drive, the shuttle slide, the shuttle conveyor and the actuators. Inputs to the controller come from a plurality of sensors throughout the system as well as a processor input from control panel. In operation, the controller receives input from sensor located in the input portion when a stack of trays has been inserted. If the controller determines there are no empty trays in the output portion or the discharge portion, the controller directs the table portion to transport the stack of trays to the output portion. The stack tray is then placed on the translatable table in the output portion and the table portion is returned to the input portion.

A signal is then provided to the table slide to raise the height of the stack tray to a pre-determined level A. After the processor has removed the components in the tray, a push button is activated which brings the shuttle into position around the empty tray. The height of the shuttle is controlled by the controller in response to inputs from sensors the shuttle. The actuators then engage the sides of the empty trays.

The shuttle is then raised by the controller to a pre-determined height. Upon reaching this height, the shuttle conveyor transports the empty tray over the discharge portion. The shuttle is then slid by the controller an amount based on input from the shuttle sensor. The sensor determines the height of the stack of trays in the discharge portion. Upon reaching the proper height, the controller provides a signal to the actuators to release the tray, which drops onto the discharge region.

Each of the pallets has a plurality of segmented bottomless drawers. As shown in several of the figures, the segments can vary in size. Each of the drawers can have a standardized or a variable height to accept varying sized products or components. Each pallet is formed of a fixer frame that optionally can have sides, a top and a bottom. Disposed between each of the drawers is a fixed flat surface that allows and facilitates the sliding of each of the bottomless drawers over the segmented table. The drawers can be formed of segmented polymer sheets or can be extruded into a monolithic structures.

After placing the empty tray back into the pallet, the shuttle is again raised to a pre-determined height and the shuttle conveyor is moved over the output portion. Upon receiving instruction from the processor, the shuttle will drop and retrieve the next available empty tray. Online grocery is a fast-changing and growing part of the competitive landscape for food retailers.

Online order for in-store pickup; Pick orders in 6 min from click until order is ready for pickup or delivery; pick robots able to pick up to five different orders at time; Drivers receive the order and it is only 6 min old; Driver enough time to deliver multiple orders at the same time; and Customers are able to order and pick-up without entering the facility.

No such facility exists that combines an automated distribution warehouse and retail facility. The combined facility reduces the footprint and reduces the overhead and labor costs while saving almost $0.17 of every dollar made that would otherwise go to labor costs.

Customers currently spend an average of ninety minutes driving to the store, picking their groceries, loading their groceries, and returning home. That is just per store; it does not include the limitations placed on stores by not being able to combine over a million different SKUs.

With the automated picking process, a large order can be picked in six minutes, and up to five large orders can be completed in six minutes with no manual intervention. The described system takes less time and provides the option for free delivery by reducing pick costs. When the delivery option is used, drivers can deliver 10 orders per hour within a small window of customer ordering. Every order is fresh and ready to go. This system is more convenient than ordering a pizza. Instead of having one pizza come to your home in 30 minutes, imagine have a week's worth of groceries and dry goods delivered to your front door within one hour.

Robots: Jack, Distribution, Pick: The robots can be operated on a crane, shuttle, or pod. When the Distribution and Pick Robots operate on a shuttle, every robot has its own shuttle. For the Automated Retail Facility a 5:1 Pick Robot to Distribution Robot ratio exists. When the Distribution and Pick Robots operate on a pod, every robot has its own pod. For the Automated Retail Facility, a 10:1 Pick to Distribution Robot ratio exists.

The Pick Robot picks the pieces for the customer basket. The robot picks for up to five different orders at time and can pick up to 576 items per pick. The Pick Robot picks by moving the metal grates to open small, SKU sized spaces underneath the item. The item then falls into the basket underneath the opening. The baskets slide from side to side underneath the picking grates to allow the right item to lower into the right basket. Each Pick Robot has five different baskets to accommodate five different, large customer orders. Once the orders are fully picked, the pick robot loads them onto a chute for bundling and delivery.

The Pick Robot opens the T-Pallet drawer using the same mechanism as the Distribution Robot. The Pick Robot picks the piece for the customer basket by closing the grates under the open drawer, opening individual grates under the item, and allowing the item to drop into the consumer basket. The robot picks for up to five different orders at time and can pick up to 576 items per pick.

The Pick Robot picks up to 576 items per pick for up to five orders at a time. Much faster than a single pick robot arm and allows for full automation. Pick Robot can run constantly with no breaks or change over, and is able to complete numerous picks in less time than a human picker who at peak capacity at optimal conditions can only pick at maximum ten orders an hour picking one order at a time.

The Distribution Robot approaches T-Pallet to pick the item and put it away into the proper algorithm defined T-Pallet. The Distribution Robot opens the drawer of the T-Pallet and closes its gates underneath the open drawer. The metal grates pull apart directly beneath the item to be picked, and the item falls into a pocket within the robot.

To put away the item, the Distribution Robot approaches the algorithm defined T-Pallet. The Distribution Robot opens the drawer of the T-Pallet and closes its gates underneath the open drawer. The metal grates pull apart directly above the item to putaway and the (rubber?) fingers that formed the storage pocket push the item into position in drawer.

The Distribution Robot can pick from one item to 576 in a single pick and can run 24-hours a day. The drawer of the T-Pallet can be partially opened to target specific items without having the entire drawer for item retrieval and put away.

Moving along the rail, pod, or shuttle, the Distribution Robot uses RFID technology to locate the piece to be picked in the T-Pallet's drawer, The Distribution Robot opens the drawer and closes its right and left gates underneath the drawer. Metal grates pull apart directly underneath the item to picked, and the item falls into a finger-formed pocket. The Distribution robot stores this item in the pocket until it reaches the destination T-Pallet for put-away.

For put-away, the destination T-Pallet holds a mix of algorithm determined items to maximize pick efficiency. The Distribution Robot approaches the T-Pallet, opens the drawer of the T-Pallet, and closes its right and left gates underneath the open drawer. The metal grates separate underneath the item to be put-away, and the fingers that formed the storage pocket push the item into the proper position in the drawer. The grates shut underneath the item, and then the Distribution Robot closes the drawer and moves on to its next task. Up to 576 items may be put away in a single put-away.

Items will be distributed to the drawers based on algorithm based on aggregate customer purchase behavior. This algorithm will allow for the most efficient distribution of items to minimize the amount of stops that the picking robot will have to make. The fewer the stops the less time the picking robot will need to complete the orders.

The cranes mounted Jack Robots remove the T-Pallets from the frames and move up and down the warehouse shelves to put the T-Pallets away. The Jack Robot can move left and right to stack the units on the shelves. Two crane units are needed per Automated Retail Facility.

The crane mounted Jack Robot moves up and down and left and via placement on the crane. The Jack Robot removes the T-Pallets from the frame and then moves the T-Pallet to the proper shelf within the Automated Retail Facility. The Jack Robot also removes the T-Pallet from the shelves to put back into the frame or onto a different shelf using a fully automated robotic system.

At a wholesale center, the items are often stored in sealed cases, where individual units are packed together in a shipping case, as they are received from a manufacturer. Cases may further be broken down and re-grouped to be stored on crates, shuttles (Walmart), or pods (Amazon) in combinations most efficient to the operation. It is inherently time consuming and labor intensive. For the standard process, manufacturers fill the boxes with product, put the boxes on pallets, load the pallets onto the trucks, and the trucks take the container to the distribution center. At the distribution center, the pallets are unloaded, boxes of products removed, and the new pallets are made with mixed products. The new pallets then go to the warehouse/retail store where the pallets are disassembled and stocked on store shelves.

Full automation. The Jack Robot directly off loads the T-Pallet from the manufacturer delivered frame to the correct warehouse shelf. This eliminates manual loading by a forklift or medial jack and eliminates manual moving and unpacking.

The T-Pallet has the standard dimension of 40″×40″×40″. Drawers within the T-Pallet can range from 2″ high to 40″ depending on the size of the SKU. The drawers can SKUs as small as prescription bottles to SKUs as large as flat screen televisions. T-Pallets are able to hold drawers of multiple heights as to store the best array of SKUs inside for the pick algorithm.

The basic frame for every T-Pallet. This construction allows for different configurations of drawers. Each drawer has adjustable compartments to hold SKUs. These drawers have no bottoms. The walls between the SKUs adjust to form the specialized compartments. Each wall measures ½″ thick. The compartments in each drawer are adjustable to hold 576 different SKUs. Different configurations can exist within each drawer.

T-Pallet configurations e.g. 1: Drawer wall configuration, e.g. 2: Drawer wall configuration, e.g. 3: Drawer wall configuration, e.g. 1: Compartment configuration, e.g. 1: Compartment configuration. New design to support automated system. Current methods include items placed on standard wooden pallets and then “shrink-wrapped” to prevent repositioning and to ensure that they stay connected. The current method also involves transporting the manufacturer packaged goods to a distribution warehouse for repackaging to on a mixed wooden pallet to go the retail center. Once the pallets reach the retail center, the pallet is broken down again and the items stocked onto store shelves. In larger, partially automated facilities, the facilities place the items in bins based on sku numbers. Each bin can only hold one SKU number for picking and put-away.

The T-Pallet eliminates significant labor costs and the need for a distribution warehouse. The pallet itself exists for full automation and eliminates the need for stockists and other service employees. By design, the T-Pallet exists for the robots to quickly pick and put-away items to make the Automated Retail Facility possible.

The T-Pallet can go straight from the manufacturer filled frames to Automated Retail Facility's shelves for product put-away. The T-Pallet is also able to hold multiple SKUs per drawer to allow for a greater number of SKUs available to be held at the Automated Retail Facility which reduces the need for multiple facilities and allows customers to complete the most about shopping at one facility. The customers save time and facility is able to capture more the customer's business.

The standardized size of the T-Pallet allows for manufacturers to use currently available equipment such as a medial jack and forklift to move the T-Pallet around in their facility. Manufacturers do not need to retool their facility to accommodate the T-Pallet.

The Distribution Robot approaches the T-Pallet and opens the specified drawer. The Distribution Robot picks the item using the described method and puts-away the product using the above described method into another T-Pallet.

The 40 ft shipping frame holds up to 40 T-Pallets from the manufacturer for delivery to the Automated Retail Facility. A standard medial jack or forklift loads the T-Pallets into the frame, and the frame loads into trailers for delivery. Once the semi-trucks reach the Automated Retail Facility, the full automation process begins.

The frame being dropped off at the Automated Retail Facility for unloading without changing the manufacturer's or shipper's processes. The manufacturer loads the T-Pallet into the frame, the frame is loaded into the shipping trailer, and the shipping trailer docks at the rear of the Automated Retail Facility. Metal hooks attach to the frame to pull it from the trailer. Once the frame is removed, the Jack Robot removes the T-Pallets from the frame and places them onto the shelves. The frames are loaded back into the trailer and sent back to the manufacturer.

The process of picking individual items from a specific storage location in a facility is known as piece-picking. Both the piece-picking and put-away happens in both distribution warehouses and retail centers, whereas case-picking or pallet-picking typically only happens at a wholesale distribution center. The process also forces the need for separate distribution warehouses, wholesale distribution centers, and retail centers. This leaves a large footprint with multiple cost overlays and a significant labor cost. The labor cost of distributing, stocking, and retail is $0.17 of every dollar made.

A fundamental problem with piece-picking and put-away is that it is inherently time consuming and labor intensive. For the standard process, manufacturers fill the boxes with product, put the boxes on pallets, load the pallets onto the trucks, and the trucks take the container to the distribution center. At the distribution center, the pallets are offloaded, boxes of products removed, and the new pallets are made with mixed products. The new pallets then go to the warehouse/retail store where the pallets are disassembled and stocked on store shelves. Time must be spent to decipher the SKU for product positioning, and an entire shift of labor can be hired to pick the mixed pallets and put away the items onto shelves.

The end customer must then pick the items from the shelf and proceed to the timely checkout process to unload, pay, and reload the items. If the customer is not able to complete their shopping at one store due to limited item capacity, then process must be repeated until all items are captured. The retailer also loses dollars to other retailers if they are not able to carry all the items at their store.

The warehouse of the Automated Retail Facility will be refrigerated to allow for grocery items. There will be a special freezer section with its own Pick Robot for frozen foods. The rear of the warehouse facility receives product deliveries.

For the Automated Retail Facility, the automated warehouse will be located at the rear of the facility. It will able to hold 1.3 million individual SKUs in a much smaller facility. Consumers will be able to walk into the front of the facility to place and pick up their orders. They have no contact with the rear of the facility. Inside, there is an automated consumer fulfillment area for order placing and pick-up. Orders may also be delivered to consumers waiting in their vehicles.

The system can pick five 40-item orders in seven minutes.

Sequence
Customer order;
Pick Robot picks items;
Items drop into consumer baskets;
Completed orders from the baskets go down a chute to processing area;
Items bundled;
Customer delivery.

Currently, for the standard process, manufacturers fill the boxes with product, put the boxes on pallets, load the pallets onto the trucks, and the trucks take the container to the distribution center. At the distribution center, the pallets are unloaded, boxes of products removed, and the new pallets are made with mixed products. The new pallets then go to the warehouse/retail store where the pallets are disassembled and stocked on store shelves. Time must be spent to decipher the SKU for product positioning, and an entire shift of labor can be hired to pick the mixed pallets and put away the items onto shelves.

The end customer must then pick the items from the shelf and proceed to the timely checkout process to unload, pay, and reload the items. If the customer is not able to complete their shopping at one store due to limited item capacity, then process must be repeated until all items are captured. The retailer also loses dollars to other retailers if they are not able to carry all the items at their store.

The retailer maintains a smaller footprint and eliminates duplicate facilities. Less money goes to labor costs robots handle the ordering, stocking, and picking. The entire facility will be automated. The speed of this method over single pick robots and people enables delivery within a very small window of time to increase customer satisfaction and repeat business. Customers may walk in to order, place the order from their cars, or order online. This method eliminates the need to charge per pick per its high efficiency picking—these are savings that can be passed down the line to make grocery delivery profitable and practical.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, which is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An apparatus for presenting components stored in segmented bottomless trays to a processor, said apparatus comprising:
a robotic base member having an input and an output portion;
a segmented table disposed between the input and output section;
a discharge area; and
a shuttle member which removes storage trays and places them in the discharge area.

2. The apparatus of claim 1 wherein the base member further includes a conveyor.

3. The apparatus of claim 1 wherein the output portion further includes a translatable table.

4. The apparatus of claim 1 wherein the output portion further includes a segmented bottomless tray slide.

5. The apparatus of claim 1 wherein the shuttle member contains a shuttle slide.

6. The apparatus of claim 1 wherein the output portion comprises a translatable table and segmented bottomless tray slide; and the shuttle member has a shuttle slide.

7. The apparatus of claim 4 wherein the segmented bottomless tray slide automatically adjusts its height to a predetermined level when an empty tray is removed.

8. The apparatus of claim 1 wherein the shuttle member contains a shuttle safety lock.

9. The apparatus of claim 1 wherein the shuttle member includes a first storage location.

10. The apparatus of claim 1 wherein the output portion further includes a translatable table segments.

11. The apparatus of claim 1 wherein the shuttle supporting member included a first storage location.

12. The apparatus of claim 11 wherein the shuttle member has a shuttle conveyor.

13. The apparatus of claim 12 wherein the base member further includes a conveyor.

14. The apparatus of claim 13 wherein the shuttle member further includes actuators for engaging the empty segmented bottomless trays.

15. The apparatus of claim 1 wherein the shuttle comprises at least one sensor for determining the location of the shuttle with respect to the segmented bottomless trays.

16. An apparatus for presenting components stored in segmented bottomless trays and removing empty trays comprising:
a base member having a conveyor, an input portion, an output portion having a translatable table, and a segmented bottomless tray slide;
a shuttle support member having a shuttle slide and safety lock;
a shuttle having a conveyor, actuators and sensors;
a discharge portion; and
a controller connected to the conveyor, shuttle, shuttle slide, conveyor, actuators and sensors, wherein a stack of segmented bottomless trays is loaded into the input portion, the conveyor conveys the stack of trays to the output portion and the shuttle removes the top tray from the stack of segmented bottomless trays and places it on the discharge portion.

17. The apparatus of claim 16 wherein the discharge portion is located above the input portion.

18. A method of presenting components stored in a stack of segmented bottomless trays and handling the empty trays, said method comprising the steps of:
providing an apparatus having a base member, having a conveyor, an input portion, an output portion having a translatable table and a segmented bottomless tray slide, a shuttle support member having a shuttle slide and a shuttle safety lock, a shuttle having a shuttle conveyor, actuators, a discharge portion, and a controller connected to the conveyor, shuttle, shuttle slide, shuttle conveyor, actuators;
moving a stack of segmented bottomless trays into the input portion;
transferring the stack of segmented bottomless trays to the output portion;
translating a segmented portion of the table to form an aperture allowing a components to fall from a top tray so as to leave the top tray empty;
translating a segmented portion of the table to close the aperture;
lowering the shuttle down to a first position;
actuating the actuators so as to engage the empty tray;
sliding the shuttle to a second position;
transferring the empty tray over the discharge portion with the shuttle conveyor;
lowering the shuttle to a third height; and
actuating said actuators to release said empty tray.
